(19) United States
(12) Patent Application Publication
(10) Pub. No.: US 2018/0369724 A1
(43) Pub. Date: Dec. 27, 2018

(54) Device for Filtering Fiber Suspensions

(71) Applicant: Valmet Technologies Oy, Espoo (FI)

(72) Inventors: Rolf Oswaldson, Gavle (SE); Kent Strid, Norrsundet (SE)

(73) Assignee: Valmet Technologies Oy, Espoo (FI)

(21) Appl. No.: 16/019,251

(22) Filed: Jun. 26, 2018

(30) Foreign Application Priority Data
Jun. 27, 2017 (SE) 1730167

(51) Int. Cl. B01D 33/21; B01D 33/46; D21D 5/06

(52) U.S. Cl. CPC B01D 33/21; D21D 5/06; B01D 33/466; B01D 33/463

(57) ABSTRACT

A vat (1) with an inlet (2) for a suspension. A rotatable inner axial part (5) with peripheral channels (7) and at least one disc-shaped filter (8) mounted to the inner axial part (5). Within the vat the suspension is contained between partition walls (16A) in which the filters rotate. The filter (8) has inner flow channels (42) for transporting filtrate to channels (7) in the inner axial part (5). The filtrate from the channels (7) is combined in one end of the inner axial part (5) into at least one vacuum forming downpipe (12). Sprays (13) (15) detach material deposited on the filters. Mounted to the top of the partition walls (16A), which form receiving chutes (16), are guide plates (14A) for guiding material down into the chutes. Spray nozzles (14B) are located below the guide plate(s) and between the partition walls (16A) to clean the filtering surface (10).

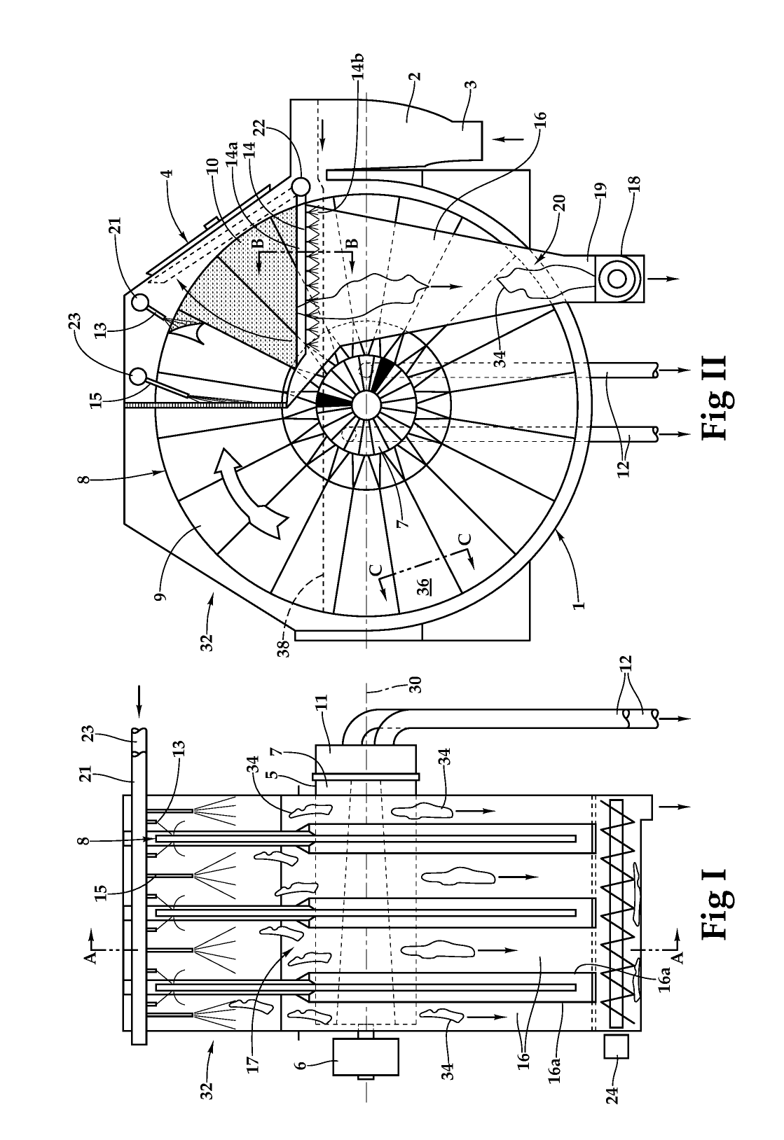

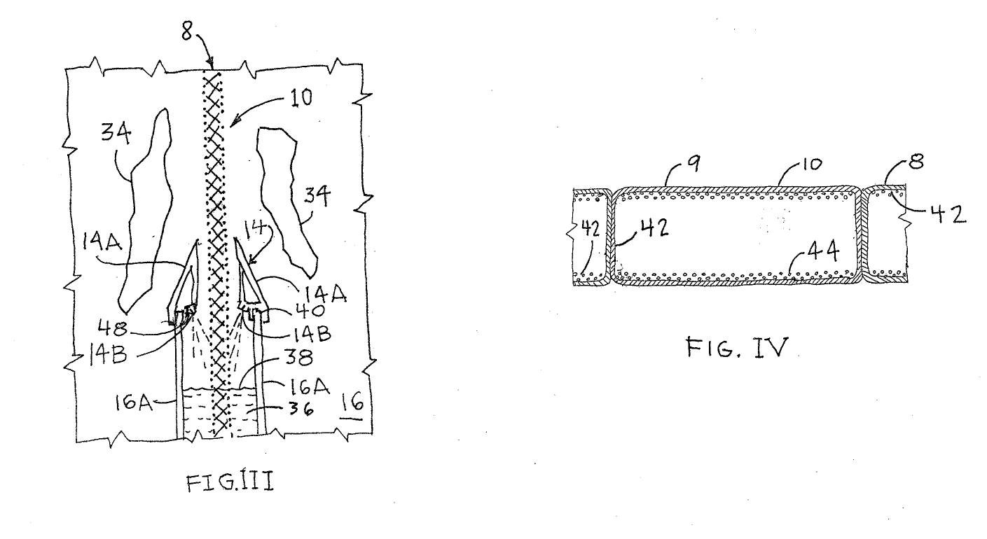

### CROSS REFERENCES TO RELATED APPLICATIONS

This application claims priority on Swedish App. No. SE 1730167, filed Jun. 27, 2017, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to disc filters in general and particularly to disc filters for filtering fiber suspensions which are comparatively easily dewatered or for fiber suspensions which are difficult to dewater.

The term “fiber suspensions” means liquids and suspensions, which contain fibers and other occurring ingredients, which are meant to be filtered out. The fibers usually mean recycled cellulose fibers, but also relates to newly produced cellulose fibers.

Mainly three relevant types of disc filters occur in this context, the first type is where between two adjacent discs for filtering there is a means for removing detached material shaped like a chute, arranged so that its lower part delivers the material to a receiving device, which is usually made up of a screw conveyor placed below the vat and extends in its longitudinal direction mainly parallel to a rotatable axis. The aim of this filter type is to filter and dewater fiber suspensions which are comparatively difficult to dewater, where it is desirable that the dry matter content of the filtered-out fiber pulp is as high as possible. Therefore, it has been selected to use a filtering principle, where the fiber suspension is first filtered in a liquid phase and then the fiber cake formed on the filter discs is dried and thereafter detached from the filtering surface of the disc. The filtering surface of the discs is thereafter washed clean with an oscillating mobile washing device, whereafter the filtering cycle is again repeated. This aim and filtering method has provided the known disc filter structure of this type.

With the second main type, instead of the internal rotating axis there is arranged a rotor therein and along its rotational axis there is arranged a conveyor for receiving material detached from the filter discs and for taking it to one end of the rotor and the filter's vat.

The third main type is where between two adjacent discs for filtering there is a means for removing detached material shaped like a chute, arranged so that its lower part delivers the material to a receiving device, which is usually made up of a screw conveyor which extends in its longitudinal direction substantially parallel to the rotatable axis, where the conveyor is placed below the vat. The aim of this type of disc filter is to filter and dewater fiber suspensions, which are relatively easily dewatered, which is achieved by the rotational direction of the adjacent discs being downwards by the means for removing detached material. By the incoming suspension being fed in from outside the filter's trough, where the filtering surfaces of the rotating discs start to sink down into the suspension, a liquid flow is created into the filter's trough and the friction created between the pulp chute and the pulp layer created on the discs during the filtering is reduced. It has not been desired to have the dry matter content of the filtered-out fiber pulp as high as possible when after the fiber cake is detached, it is diluted with a washing liquid from an oscillating washing nozzle.

These known disc filter techniques have undesired drawbacks, such as: the first main type has the drawback that the filtered-out material amassed on the discs is partially pulled off during the end phase of the filtering cycle due to friction between the rotating discs and the stationary chutes placed between the discs, which causes the material to thicken in the fiber suspension in the vat. This is prevented from happening by diluting the incoming fiber suspension down to such a low concentration that the amassed fiber layer on the discs becomes so thin that it is not scraped off against the sides of the chute. This diluting of the incoming suspension yields a comparatively low capacity and makes the filtering apparatus less economical to use. Alternatively, the discs can be placed at a moderately increased axial distance from each other, which also makes the filtering apparatus large and less economical. In order to avoid scraping and thus thickening in the filter's vat, the distance between the chute and the rotating discs must be made to be large, which causes also this solution to make the filtering apparatus less economical.

The second main type of disc filter has the drawback that it is a comparatively expensive construction with an inner longitudinal screw conveyor placed inside the filter's rotor part. This means that the inner rotor part must be made rather bulky. The placement of the screw conveyor also makes the channel design of the inner rotor part more expensive, since these must be formed in a coronal shape outside of the internally placed screw conveyor. The filtered-out material which falls onto the screw conveyor, will additionally be able to fall onto and stick to the rotor's channels. One big drawback is also that a breakdown of the conveyor makes the entire filter unusable.

The third main type of disc filter has the drawback that filtered-out material is diluted with spray water from the oscillating washing device of the filtering surfaces. This leads to the filtered-out material being diluted without any control, and that means for removing filtered-out material cannot be designed in an optimal way to avoid that the filtered-out pulp sticks to the edge of these means. Filtered-out pulp also sticks to the oscillating nozzle when its spray pipe swings out over the area where the filtered-out pulp falls down. The oscillating washing nozzle also does not offer a fully good washing of the entire filtering surface, depending on the filter sectors' speed relative to the oscillating nozzle's speed, and when the filtered-out pulp can fall between the washing nozzles and the filtering surfaces of the discs.

### SUMMARY OF THE INVENTION

The object of the present invention is to increase the operational reliability and improve the filtering result of a disc filter for filtering fiber suspensions which are characteristically comparatively easily dewatered. The invention can also be used for suspensions which are difficult to dewater.

The object of the invention is to further develop a device for filtering fiber suspensions, having a vat with an inlet for the suspension, an inner axial part which is rotatable about its axis, and with peripheral channels arranged in the vat and at least one disc-shaped filter element which exhibits filter sectors, which are orientated at an angle toward the geometrical axis of the rotatable axis, where the filter element has an external filtering surface and inner flow channels for transporting filtrate, which passes through the filtering surface, to one or more filtrate channels in the inner rotating axis, devices for detaching filtered-out material of the suspension, deposited on the filtering surface, and a washing device for washing the filtering surface and transporting away the filtered-out material down into at least one receiving chute, which is arranged on the side of the vat, so that from a process point of view a more improved filtering device for filtering easily filtered fiber suspensions is obtained, where the filtered-out material is not diluted by spray water from the washing device for the filtering surfaces. The invention can also be used for suspensions which are difficult to dewater.

In order to be able to use the filter in this way and obtain full control of the outgoing pulp's concentration, it is required that the washing device for filtering surface of the discs is placed outside the pulp chute's opening and thus does not dilute the outgoing pulp in an uncontrolled manner with spray water from the washing device for the filtering surface of the discs.

The pulp chutes can through this solution advantageously be designed with a maximal opening in order to achieve free fall of the filtered-out pulp.

This aim is fulfilled according to the invention by giving the device a washing device (having at least one guide plate and spray nozzles where the spray nozzles are located below the guide plate(s).

Advantageously according to the invention spray nozzles of a washing device of the filtering device are located in a space formed between a guide plate of the filtering device and chutes of the filtering device, advantageously below the guide plate.

According to advantageous features of the invention a guide plate of the filtering device is located above the washing location of the filtering surfaces such that the guide plate guides the filtered-out material and thereafter the filtering surface is washed. In accordance with an advantageous example spray nozzles of the washing device are located in immediate vicinity below the guide plate and thus in connection with the guide plate. According to a particularly advantageous example the guide plate and the spray nozzles are integrated to form a one-piece structure. Alternatively, a separated guide plate and spray nozzles can be used. Particularly advantageously the spray nozzles are located on a bottom surface 48 of the guide plate. Thus, washing before the liquid level of the filtering device is achieved. According to a particularly advantageous example the guide plate is located on top of pulp chutes' upper edge 40 and the spray nozzles are placed in the immediate vicinity thereof.

The design of the invention offers the following advantages:

1. No uncontrolled dilution of the filtered-out material with washing liquid from the washing device.
2. Prevention of filtered-out material from falling and sticking to the washing device's pipes and its spray nozzles.
3. Prevention of filtered-out material from falling between the washing nozzles and filtering surfaces.
4. Optimized size and design of the receiving chutes' openings for the filtered-out material which prevents the filtered-out material from sticking to the chutes' openings and causing blockage of these.
5. With stationary nozzles the entire filtering surface is washed by one disc during one rotation lap.
6. No oscillating spray pipes between the rotating discs.
7. The above-mentioned related advantages offer a better process operation with an even and comparatively high outgoing concentration and fewer operational disturbances and service needs when filtering relatively easily dewatered fiber suspensions compared to a disc filter with a chute and a washing device according to prior art.
8. Higher production capacity.

The filtering device according to the invention and its advantageous features also provides for a higher level of filtering and thus a greater capacity is achieved.

Furthermore, a possibility of changing direction of the filtering is possible due to the arrangement of the spray nozzles in the filtering device according to the invention and its advantageous features.

Further advantages of the invention will be discussed as follows with reference to the drawings. Hereafter follows a description of an exemplary embodiment of the invention.

### BRIEF DESCRIPTION OF THE DRAWINGS

FIG. I is a schematic partially sectional side view of the filter device according to the invention.

FIG. II is a cross-sectional view of the apparatus of FIG. I taken along section line A-A.

FIG. III is an enlarged fragmentary cross-sectional view of the apparatus of FIG. II taken along section line B-B.

FIG. IV is a fragmentary cross-sectional view of the apparatus of FIG. III taken along section line C-C.

### DESCRIPTION OF THE PREFERRED EMBODIMENTS

The filter device 32 according to the invention will in the following be described as suited for dewatering and thickening of fiber suspensions, which are comparatively easily dewatered, but the filter device can also advantageously be used for suspensions, which are difficult to dewater.

The filter device consists of a U-shaped vat 1, shown in FIG. II, with gables and a support structure and an inlet 2 for fiber suspensions. The inlet 2 is arranged along one side of the vat 1. An inlet pipe 3 leads to the inlet 2. The upper part of the vat is sealed with one or more hatches 4, which can be opened.

In the vat 1 there is arranged an inner axial part 5, shown in FIG. I, which is rotatable about a geometric axis 30 by an actuator 6 and has flow channels 7 and a plurality of external disc-shaped filter elements 8 placed across the geometric axis 30 of the inner axial part 5. The disc-shaped filter elements 8 are orientated substantially perpendicularly to the rotational axis 30 of the axial part 5. The individual disc-shaped filter element 8 extends in a ring-like configuration around the inner rotor part 5. This ring configuration of the disc-shaped filter element 8 is divided into a number of filter sectors 9, as shown in FIG. II. As shown in FIG. IV, each filter sector 9 has an external filtering surface 10, and inner channels 42 formed by in inner perforated metal frame 44 for transporting filtrate i.e., the filtered water, which has passed through the filtering surface 10, e.g., a filter cloth, to one or more flow channels 7 in the inner rotatable axial part 5.

As shown in FIG. I, the flow channels 7 in the rotatable axial part 5 exit into a device 11 called a filtrate valve, meant to collect the water (filtrate) flow from a number of flow channels 7 into at least one pipe 12 called a downpipe, in which the water falls through and thus creates the necessary vacuum required for the filtering method.

The filter device comprises devices 13 for detaching filtered out fibers and deposited on the filtering surface 10. The detaching devices 13 consist of spray nozzles placed to remove the layer of filtered out fibers from the filter sectors as they rotate by, with water fed in via a connecting distribution pipe 21.

The filter device 32 additionally comprises a washing and deflection device 14, which has at least two functions, namely to wash the filtering surface 10 and to steer the filtered-out fiber material 34 into the chutes 16, also called compartments or pulp chutes. As shown in FIG. I, the chutes 16 are formed by partition walls 16A that keep the filtered-out material 34 separate from washing liquid. The washing device 14 comprises a guide plate 14A placed on top of the chutes' 16 upper edge for guiding the filtered-out material 34 towards chutes' opening 17. The washing device 14 is also comprised of spray nozzles 14B below the guide plate 14A, the spray nozzles 14B are placed to wash the filter elements' 8 filtering surface 10 as they are rotated by the washing device 14, primarily by spraying with washing liquid, e.g., water fed via a connecting distribution pipe 22. The spray nozzles 14B are located after guide plates 14A such that washing liquid is guided away from the filtered-out material 34 and thus mixing of the washing liquid and the filtered-out material 34 is avoided. The washing device's main secondary function is to aid in transporting away filtered-out fiber material 34 through the chutes 16 down to the collecting screw conveyor 18 situated below the filter's vat 1 without water from the washing device's nozzles 14B diluting the concentration of the filtered-out fiber material. The spray nozzles 14B clean the filtering surface before the filtering surface sinks down to the suspension 36. By this compact washing device 14 arrangement is possible to increase the fiber suspension level 38 in the vat 1. The washing device 14 is foldable for easier access to its spray nozzles and cleaning of them. Between each disc there are devices made up of spray nozzles 15 placed to flush the filtered-out material down into the chutes 16 with water fed in via a connecting distribution pipe 23.

The present invention has primarily improved the operational reliability and filtering possibilities when filtering easily dewatered fiber suspensions, partly through placing the triangular stationary washing device 14 on top of the chutes' 16 upper edge 40, which steers the pulp, which ends up on these, toward the chutes' opening 17, and that the chutes' opening 17 has been maximized in order to obtain as free and safe a fall space as possible for the filtered-out material down into the receiving transport member 18 with an actuator 24, for transportation away from the filter device 32.

Knowing the importance of the filtering method providing an even predetermined outgoing concentration of filtered-out material and that the filtering surface of the filter discs must be kept clean to obtain an optimal filtering opportunity, and further that filtered-out material does not have an opportunity to stick to and cause blockages in the chutes between the filter's rotating discs, the above-mentioned improvements provide the following:

1. A controlled filtering result is obtained when the washing device 14 placement makes possible a controlled and stable outgoing concentration of the outgoing filtered-out material.
2. A more reliable operation is obtained when filtered-out material cannot fall on the spray nozzles placed beneath the washing device 14 and thus cause shutdowns and that the washing device 14 is designed like a guide plate 14A such as a contactless scraper to steer filtered-out pulp down into the chute opening 17. The guide plate 14A is located at a distance from a filtering surface 10.
3. A further increased operational reliability is obtained also when the conventional oscillating spray pipes between the filter's discs are replaced with a stationary spray device 14 placed on top of the receiving chutes' 16 upper edges. Through this placement the filtering surface of the filter's discs are washed completely during only one rotational lap by the discs 8 with the stationary washing device 14, which is of great importance when a clean washed filtering surface 10 is a requirement for obtaining a maximal capacity, which is not possible with the conventional oscillating washing device, with which it can take up to several hours before the entire filtering surface is washed, resulting in loss of capacity. The stationary washing device 14 is also foldable for easy access to the device's spray nozzles for cleaning.
4. Reduced operational disturbances are obtained when the receiving chutes' 16 opening 17 is maximized, which prevents filtered-out material from sticking to and blocking the chutes' opening.
5. Higher production capacity is obtained because the fiber suspension level 38 in the vat can be raised up by this washing device 14 arrangement.

The above improvements offer an overall controlled filtering method with a controlled concentration of filtered-out fiber material and over time a maintained high capacity and increased operational reliability with minimized operational disturbances.

I claim:

1. A device for filtering fiber suspensions, comprising:
a vat with an inlet for connection to a source of fiber suspension;
an inner axial part with peripheral channels mounted within the vat to rotate about a rotational axis;
at least one disc-shaped filter element mounted to the inner axial part at an angle to the rotational axis, wherein the at least one disc-shaped filter element has a plurality of filter sectors;
wherein the filter element has an external filtering surface and inner flow channels for transporting filtrate, which passes through the filtering surface, to at least one filtrate channel in the inner axial part:
devices for detaching material filtered-out of the fiber suspension and deposited on the filtering surface;
a chute having partition walls which is arranged on a side of the vat and positioned to receive detaching material filtered-out of the fiber suspension after it is detached from the filtering surface;
a washing and deflection device for washing the filtering surface and transporting away the filtered-out material down into the chute; and
wherein the washing and deflection device has at least one guide plate and spray nozzles and that the spray nozzles are located below the guide plate.

2. The device of claim 1 wherein the spray nozzles are spaced from the at least one disc-shaped filter element and located in a space formed between a chute partition wall of the chute and the at least one disc-shaped filter element.

3. The device of claim 1 wherein the guide plate and the spray nozzles are integrated in a one-piece structure which forms the washing and deflection device.

4. The device of claim 3 wherein the spray nozzles are located on a bottom surface of the guide plate.

5. The device of claim 1 wherein the washing and deflection device is pivotally mounted to the vat, to rotate for cleaning of the spray nozzles.

6. The device of claim 1 wherein the inlet is arranged on a side of the vat and defines a level at which fiber suspension enters the vat where the filter sectors start to sink down into the suspension.

7. The device of claim 1 wherein the washing and deflection device is positioned on top of an upper edge of the receiving chute.

8. The device of claim 1 wherein the guide plate is located at a distance from the filtering surface.

9. The device of claim 1 wherein the guide plate forms a contactless scraper.

10. A device for filtering fiber suspensions, comprising:
a vat with an inlet for connection to a source of fiber suspension, the inlet defining an inlet level at which fiber suspension enters the vat;
an inner axial part with a plurality of filtrate channels, the inner axial part mounted within the vat to rotate about a rotational axis;
a plurality of disc-shaped filter elements mounted to the inner axial part substantially perpendicular to the rotational axis, wherein each disc-shaped filter element has a plurality of filter sectors;
wherein each filter element has two sides covered with an external filtering surface and inner flow channels for transporting filtrate to at least one filtrate channel in the inner axial part:
devices for detaching material filtered-out of the fiber suspension and deposited on the filtering surface;
a plurality of chutes each having a partition wall with an upper edge spaced from one of the external filtering surfaces of the plurality of disc-shaped filter elements, wherein the upper edges extend above the inlet level, and wherein each chute is positioned to receive detaching material filtered-out of the fiber suspension after it is detached from the filtering surface;
washing and deflection devices for washing the filtering surfaces and guiding the filtered-out material down into one of the receiving chutes;
wherein each of the washing and deflection devices is mounted to one of the partition wall upper edges; and
wherein each washing and deflection device has at least one guide plate and a plurality of spray nozzles, wherein the spray nozzles are located below the at least one guide plate and above the inlet level in a space formed between one of the partition walls and one of the external filtering surfaces, wherein the spray nozzles are directed to clean said one of the external filtering surfaces.

11. The device of claim 10 each washing and deflecting device comprises said at least one guide plate and the spray nozzles integrated in a one-piece structure.

12. The device of claim 10 wherein the washing and deflection devices are pivotally mounted to the vat, to rotate to and away from said one of the partition wall upper edges for cleaning of the spray nozzles.

13. The device of claim 10 wherein the inlet is arranged on a side of the vat.

14. The device of claim 10 wherein the guide plates are closely spaced from and not engaged with the filtering surfaces.
